(19) United States
(12) Patent Application Publication
(10) Pub. No.: US 2009/0310257 A1
(43) Pub. Date: Dec. 17, 2009

(54) HEAD SLIDER AND MAGNETIC STORAGE DEVICE WITH HEAD SLIDER

(75) Inventors: Takayuki Musashi, Kawasaki (JP); Hiroshi Chiba, Kawasaki (JP); Susumu Ogata, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/365,699

(22) Filed: Feb. 4, 2009

(30) Foreign Application Priority Data
Jun. 11, 2008 (JP) 2008-153363

(51) Int. Cl. G11B 5/60

(52) U.S. Cl. 360/234.3; G9B/5.229

(57) ABSTRACT

A head slider includes a slider that is disposed at a tip of a supporting member, floats with an air flow occurring due to rotation of a storage medium, and has a medium facing surface onto which a water-repellent material is applied, with an area near the magnetic head being exposed; and a magnetic head that is disposed at an air outflow end side of the slider and has a recording element and a reproducing element.

### CROSS-REFERENCE TO RELATED APPLICATION(S)

This application is based upon and claims the benefit of priority of the prior Japanese Patent Application No. 2008-153363, filed on Jun. 11, 2008, the entire contents of which are incorporated herein by reference.

### FIELD

The present invention relates to a header slider with a magnetic head having a recording element and a reproducing element to cause the magnetic head to float over a storage medium, and a magnetic storage device with the head slider.

### BACKGROUND

A magnetic storage device stores information in a magnetic disk or reproduces information from the magnetic disk by using a head slider on which a recording element and a reproducing element are formed. In reading and reproduction, the head slider floats over the magnetic disk by keeping a slight distance away from the magnetic disk. A distance between the recording element on the floating head slider and the surface of the magnetic disk or a distance between the reproducing element and the surface of the magnetic disk is called a magnetic spacing.

In recent years, with a significant increase in recording density of a magnetic disk, the floating height of the head slider is set lower. In the magnetic disk with a high recording density, the area where 1 bit is stored (bit length) is small. To reproduce information from feeble magnetism occurring from this small area, the magnetic spacing is required to be small so as to cause the reproducing element to be near the surface of the magnetic disk. Therefore, the floating height of the head slider is set low.

Meanwhile, on the magnetic disk, contamination such as volatile organic substances and dust particles are present, and may be attached to the head slider. When such substances are attached to the head slider while it is floating with a low floating height, the head slider cannot stably float over the magnetic disk and makes contact with the magnetic disk, which is called a head crush. To get around this, a technology of forming a lubricating layer on a medium facing surface of the head slider to prevent attachment of substances is known (for example, refer to Japanese Laid-open Patent Publication No. 2006-12377).

### SUMMARY

According to an aspect of the invention, a head slider includes a slider that is disposed at a tip of a supporting member, floats with an air flow occurring due to rotation of a storage medium, and has a medium facing surface onto which a water-repellent material is applied, with an area near the magnetic head being exposed; and a magnetic head that is disposed at an air outflow end side of the slider and has a recording element and a reproducing element.

According to another aspect of an embodiment, a head-slider manufacturing method of manufacturing a head slider with a magnetic head has a recording element and a reproducing element to cause the magnetic head to float over a storage medium. The method includes forming a lubricating layer on a medium facing surface of the head slider; irradiating a portion of the lubricating layer formed in the forming except a portion near the magnetic head with a high energy beam; cleaning the lubricating layer irradiated with the high energy beam in the irradiating by using a solvent that can solve a lubricating agent that forms the lubricating layer.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 is a drawing of the configuration of a magnetic storage device according to an embodiment;

FIG. 2 is a drawing that schematically depicts a state in which a head slider floats over a disk;

FIG. 3 is a drawing of an example of a medium facing surface of the head slider;

FIG. 4 is an A-A-line cross section of the head slider;

FIG. 5 is a drawing for explaining a range of the medium facing surface to be exposed;

FIG. 6 is a drawing for explaining a magnetic-spacing loss;

FIG. 7 is a drawing of a relation between the magnetic spacing loss and the film thickness of a lubricating layer formed on the medium facing surface;

FIG. 8 is a flowchart of a first head-slider manufacturing process according to the present embodiment;

FIG. 9A is a drawing for explaining a step of immersing the head slider into a lubricant solution;

FIG. 9B is a drawing for explaining a step of pulling up the head slider at a predetermined speed;

FIG. 9C is a drawing for explaining a step of forming a resist near the head;

FIG. 9D is a drawing for explaining a step of irradiating the lubricating layer with an ultraviolet ray;

FIG. 9E is a drawing for explaining a step of removing the resist;

FIG. 9F is a drawing for explaining a step of cleaning a dilute solvent;

FIG. 10 is a flowchart of a second head-slider manufacturing process according to the present embodiment;

FIG. 11A is a drawing for explaining a step of forming a resist near the head;

FIG. 11B is a drawing for explaining a step of vapor-depositing a lubricating agent onto the medium facing surface of the head slider;

FIG. 11C is a drawing for explaining a step of removing the resist; and

FIG. 11D is a drawing for explaining a step of irradiating the lubricating layer with an ultraviolet ray.

### DESCRIPTION OF EMBODIMENT(S)

As described previously, forming a lubricating layer on a medium facing surface of the head slider prevents attachment of substances. However, the head slider having a lubricating layer formed on the medium facing surface increase the magnetic spacing by the amount corresponding to the thickness of the lubricating layer. In this technology of preventing attachment of substances, while attachment of substances onto the head slider can be prevented, an increase in magnetic spacing disadvantageously restricts an increase in recording density. Thus, an important problem is to form a lubricating layer on the medium facing surface of the head slider to obtain an effect of preventing attachment of substances and also to reduce an increase in magnetic spacing.

With reference to the attached drawings, an exemplary embodiment of the head slider and the magnetic storage device with the head slider according to the present invention is explained in detail below.

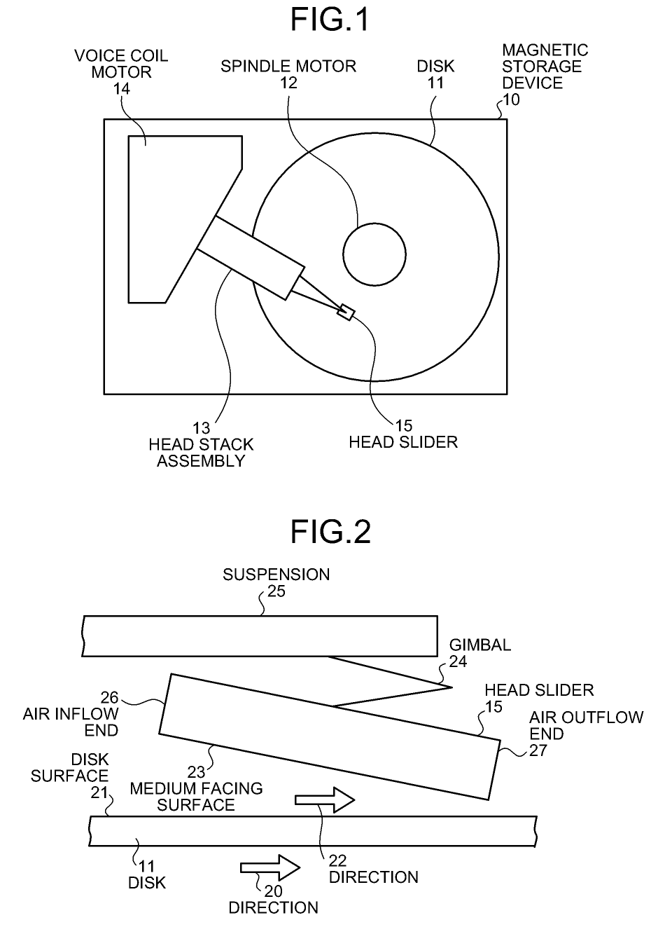

First, the configuration of a magnetic storage device according to an embodiment is explained by using FIG. 1. FIG. 1 is a drawing of the configuration of the magnetic storage device according to the present embodiment. As depicted in FIG. 1, a magnetic storage device 10 includes a disk 11, a spindle motor 12, a head stack assembly 13, a voice coil motor 14, and a head slider 15.

The disk 11 is a storage medium having information recorded thereon, being driven by the spindle motor 12 for rotation. The head stack assembly 13 is driven by the voice coil motor 14, and has its tip move along an arc. The head slider 15 is disposed at the tip of the head stack assembly 13. The head slider 15 is explained below.

FIG. 2 is a drawing that schematically depicts a state in which the head slider floats over a disk. As depicted in FIG. 2, the disk 11 rotates in a direction 20. With the disk 11 rotating, an air flow in a direction 22 occurs on a disk surface 21. Due to this air flow, the head slider 15 receives a pressure on a medium facing surface 23. Also, the head slider 15 receives a force pressing it onto the disk surface 21 from a suspension 25, which is part of the head stack assembly 13 depicted in FIG. 1, via a gimbal 24.

With the pressure and pressing force mentioned above, the head slider 15 floats over the disk 11 with a slight distance away from the disk surface 21. At this time, the head slider 15 floats over the disk surface 21 with a distance from the disk surface 21 to an air inflow end 26 being longer than a distance from the disk surface 21 to an air outflow end 27. An angle formed by the disk surface 21 and the medium facing surface 23 is hereinafter referred to as a pitch angle.

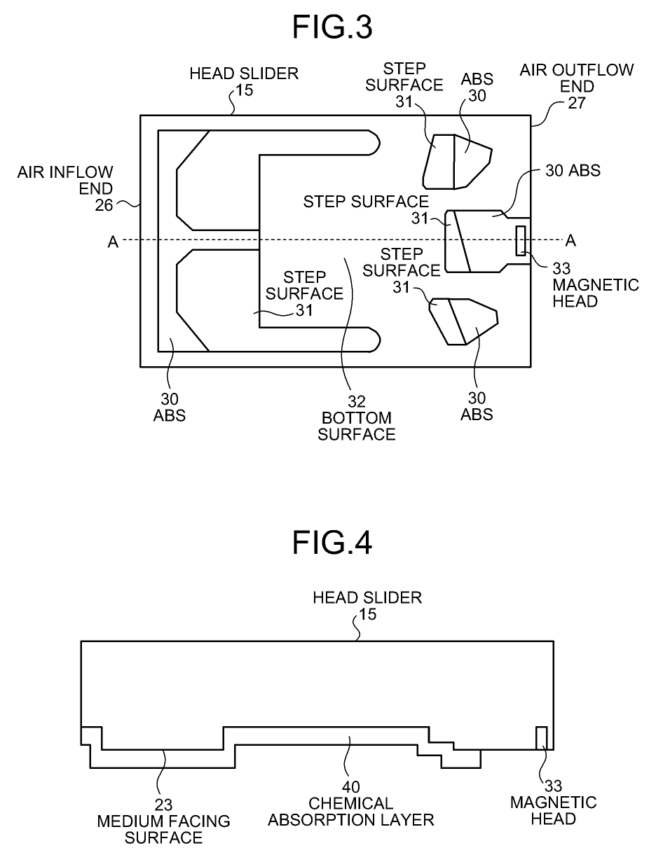

Next, the medium facing surface 23 of the head slider 15 is explained. FIG. 3 is a drawing of an example of the medium facing surface of the head slider. As depicted in FIG. 3, the medium facing surface of the head slider 15 is not flat but has Air Bearing Surfaces (ABSes) 30, step surfaces 31, and a bottom surface 32. With reference to the bottom surface 32, the step surfaces 31 are the highest, followed by the ABSes 30. A magnetic head 33 is formed on a center ABS 30 of the ABSes 30 on the air outflow end 27 side, and has a recording element and a reproducing element (not depicted). With a positive pressure and a negative pressure occurring on the ABS 30, the step surfaces 31, and the bottom surface 32 being combined together, the head slider 15 stably floats over the disk.

Next, the head slider 15 is explained by using a cross section along an A-A line in FIG. 3. FIG. 4 is an A-A-line cross section of the head slider. As depicted in FIG. 4, the head slider 15 is formed through a water-repellent process of applying a chemical absorption layer 40 onto the medium facing surface 23 with a portion near the magnetic head 33 being exposed. The chemical absorption layer 40 is formed as a result of a chemical reaction between water-repellent resin and the medium facing surface 23. The water-repellent resin may be a physical absorption layer formed by physical absorption of the water-repellent resin and the medium facing surface 23. The chemical absorption layer 40 is less dispersible than the physical absorption layer. As a water-repellent resin, Perfluoropolyether (PFPE) with a CF₃ group attached to its terminal as a functional group is used, for example.

Forming the chemical absorption layer 40 is merely an example of the water-repellent process, and any water repellent process may be performed as long as a portion near the magnetic head 33 is exposed. As one example of the water-repellent process, a fluorinated carbon film may be formed on the medium facing surface 23 of the head slider 15. Also, as another example of the water-repellent process, a fluoroalkyl compound having a silane group may be attached to the medium facing surface 23 of the head slider 15.

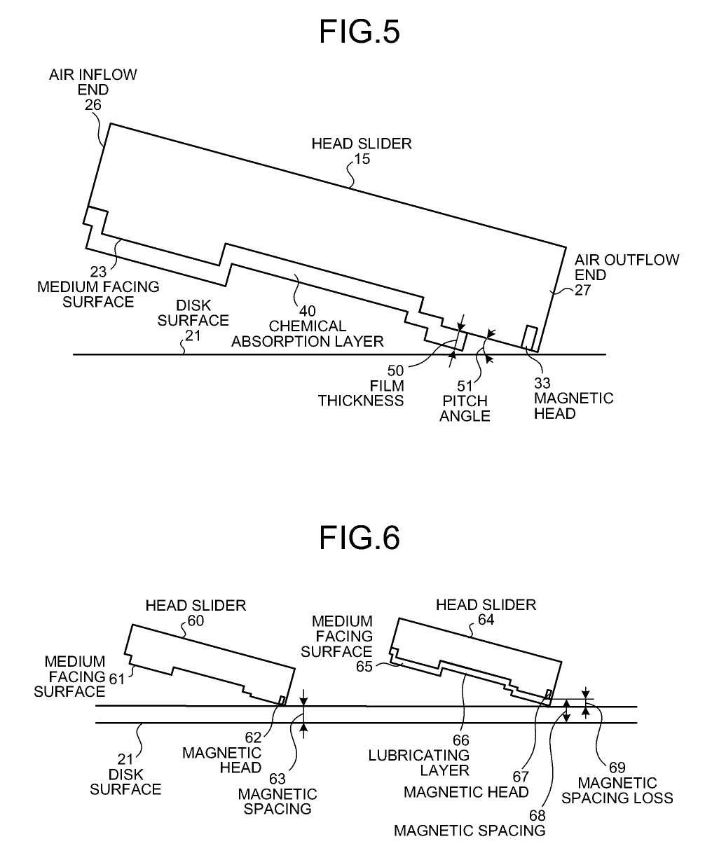

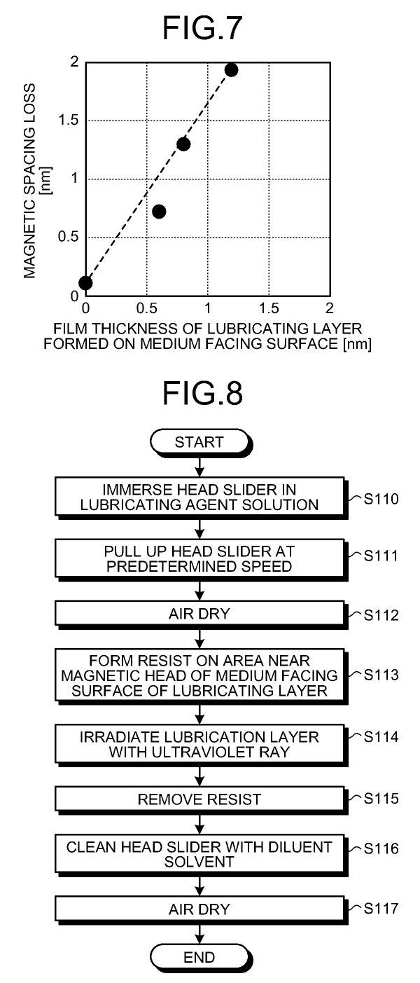

FIG. 5 is a drawing for explaining a range of the medium facing surface to be exposed. As depicted in FIG. 5, when a film thickness 50 of the chemical absorption layer 40 formed on the medium facing surface 23 is X and a pitch angle 51 when the head slider 15 floats is θ, a range of the medium facing surface 23 away from the air outflow end 27 by a distance of X/tan θ to the air inflow end 26 side is preferably exposed without the chemical absorption layer 40 being formed. For example, when the film thickness 50 is 1 nanometer and the pitch angle is 150 microradians, the chemical absorption layer 40 is formed from a position provided 7 micrometers away from the magnetic head 33 to the air inflow end 26 side. In this case, irrespectively of the film thickness 50 of the chemical absorption layer 40, the magnetic spacing representing a distance between the magnetic head 33 and the disk surface 21 is minimum. The reason why the magnetic spacing is minimum is explained below by using FIGS. 6 and 7.

FIG. 6 is a drawing for explaining a magnetic-spacing loss. As depicted in FIG. 6, it is assumed that a head slider 60 and a head slider 64 are identical in size, shape, shape of the medium facing surface, and others. It is assumed that the head slider 60 does not have a lubricating layer formed on its medium facing surface 61, whilst the head slider 64 has a lubricating layer 66 with a predetermined thickness formed on its medium facing surface 65. A magnetic spacing 63 representing a distance from a magnetic head 62 to the disk surface 21 when the head slider 60 floats over the disk surface 21 is taken as a reference value. A difference between this reference value and a magnetic spacing 68 representing a distance from a magnetic head 67 of the head slider 64 to the disk surface 21 is a magnetic spacing loss 69. The magnetic spacing loss 69 is calculated by experimentally finding an intensity of a reproducing signal from the magnetic head 67 with reference to the intensity of a reproducing signal from the magnetic head 62 and converting an attenuance of the reproducing signal with the Wallace's equation.

FIG. 7 is a drawing of a relation between the magnetic spacing loss and the film thickness of a lubricating layer formed on the medium facing surface. As depicted in FIG. 7, as the lubricating film formed on the medium facing surface is thicker, the magnetic spacing loss is larger. That is, when a lubricating layer is formed on the medium facing surface of the head slider, the magnetic spacing increases. When no lubricating film is formed on the medium facing surface, little magnetic spacing loss occurs. When a magnetic spacing loss of the head slider according to the present embodiment is found through a technique similar to the above, the same value as that when no lubricating film is formed on the medium facing surface. That is, in FIG. 5, the magnetic spacing of the head slider 15 is not influenced by the film thickness 50 of the chemical absorption layer 40 and can take a minimum value. Also, as a result of obtaining an effect of preventing attachment of substances by the chemical absorption layer 40, a head crush can be prevented.

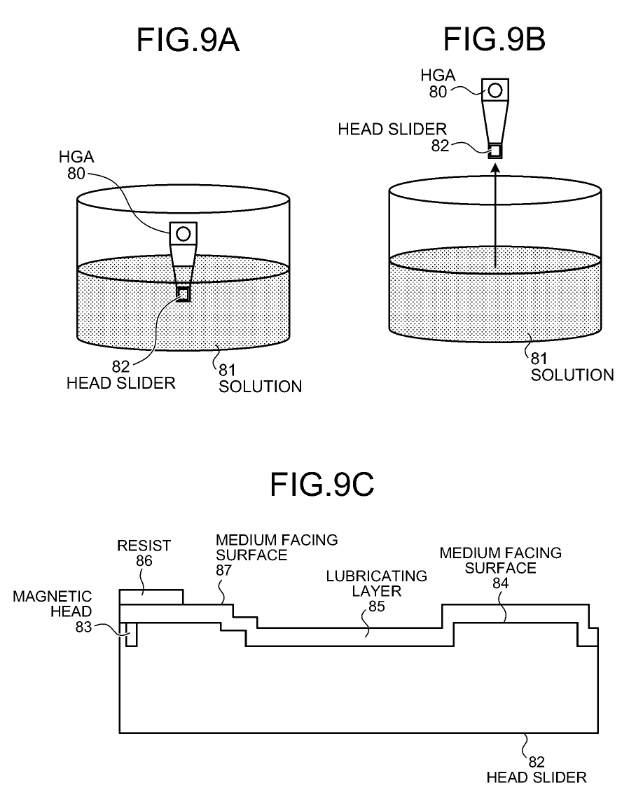

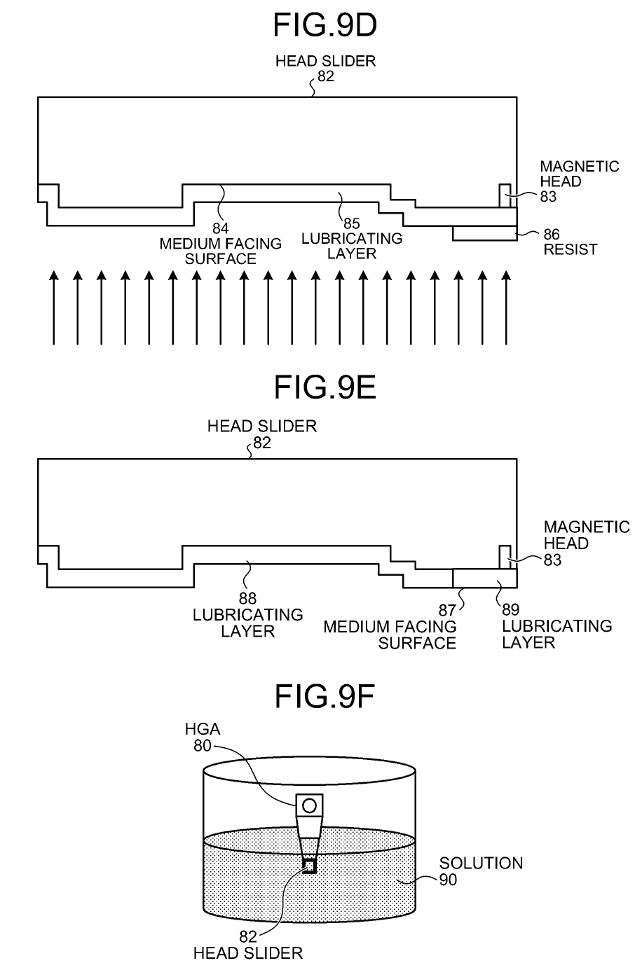

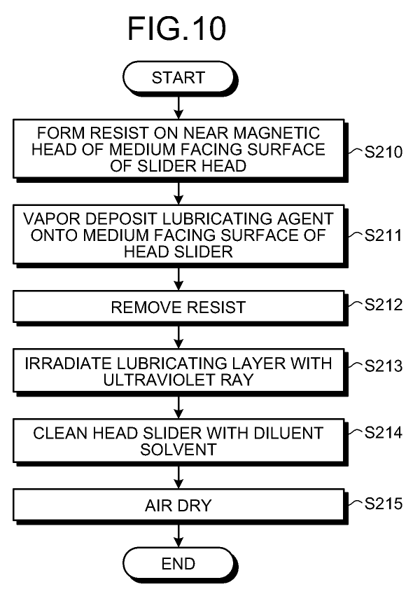

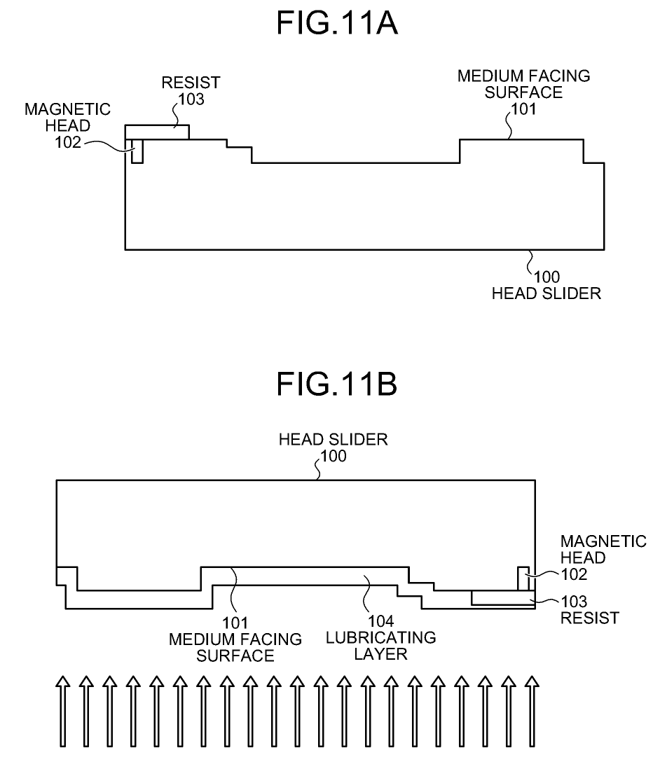

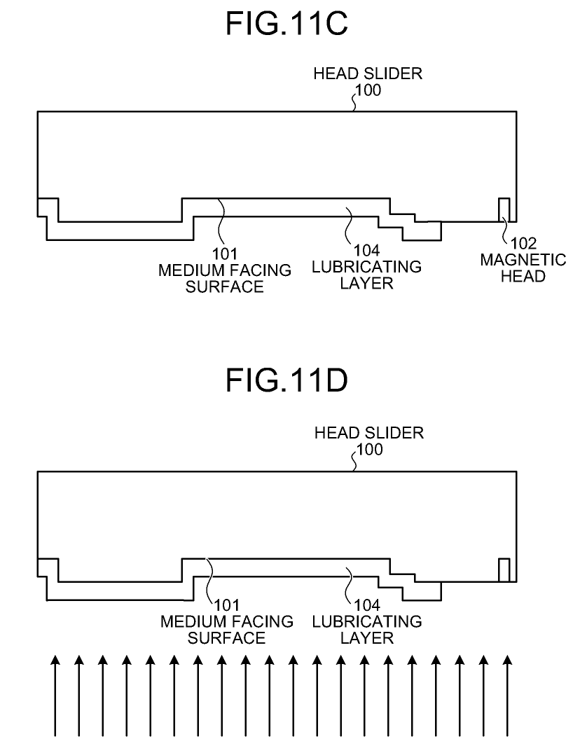

Next, a head-slider manufacturing method according to the present invention is explained. A first manufacturing method is first explained by using FIGS. 8 and 9A to 9F, and then a second manufacturing method is explained by using FIGS. 10 and 11A to 11D.

FIG. 8 is a flowchart of the first head-slider manufacturing process according to the present embodiment. As depicted in FIG. 8, a head slider is immersed in a lubricating agent solution (Step S110). Specifically, with reference to FIG. 9A for explanation, a tip of a Head Gimbal Assembly (HGA) 80 is immersed in a solution 81. The HGA 80 is a component having a head slider 82 and a suspension holding the head slider 82 integrally formed. The solution 81 is obtained by dissolving a lubricating agent, such as PFPE, in a diluent solvent at a predetermined concentration.

Next, the head slider is pulled up at a predetermined speed (Step S111), and is then air dried (Step S112). Specifically, with reference to FIG. 9B for explanation, the HGA 80 immersed in the solution 81 is pulled up from the solution 81 at a predetermined speed. Then, if the HGA 80 is left, the diluent solvent evaporates. With this, a lubricating layer formed of a predetermined lubricating agent is formed on the medium facing surface of the head slider 82. The thickness of the lubricating layer is determined by the concentration of the solution 81 or the pulling-up speed.

Next, a resist is formed on a portion near the magnetic head of the medium facing surface of the lubricating layer (Step S113). Specifically, with reference to FIG. 9C for explanation, on a medium facing surface 84 of the head slider 82, a lubricating layer 85 is formed with a predetermined film thickness, and a resist 86 is formed on a medium facing surface 87 of the lubricating layer 85 formed near a magnetic head 83.

Next, the lubricating layer is irradiated with an ultraviolet ray (Step S114). Specifically, with reference to FIG. 9D for explanation, the medium facing surface 84 of the head slider 82 is irradiated with an ultraviolet ray. With this, a chemical reaction occurs between the medium facing surface 84 and the lubricating layer 85 except the portion where the resist 86 is formed. In place of an ultraviolet ray, for example, an X ray, an electron beam, a converged ion beam, laser light of infrared radiation, or others may be radiated as a high energy beam.

Next, the resist is removed (Step S115). Specifically, with reference to FIG. 9E for explanation, the resist formed on the medium facing surface 87 of a lubricating layer 89 is removed. A chemical reaction occurs with the medium facing surface 84 of the head slider 82 by an ultraviolet ray, and therefore a lubricating layer 88 becomes a chemical absorption layer from a physical absorption layer. On the other hand, as for the lubricating layer 89, the ultraviolet ray is interrupted by the removed resist, and therefore no chemical reaction occurs with the medium facing surface 84, and therefore the lubricating layer 89 is still a physical absorption layer.

Next, the head slider is cleaned with the diluent solvent (Step S116), and is then air dried (Step S117), thereby ending the process. Specifically, with reference to FIG. 9F for explanation, after the steps explained with reference to FIGS. 9A to 9E, the HGA 80 is immersed in a solution 90. The solution 90 is a pure diluent solvent for use in dilution of the lubricating agent, such as PFPE. With this, of the lubricating layer formed on the head slider 82, the lubricating layer left as the physical absorption layer is removed. Then, the HGA 80 is left, and the diluent solvent evaporates, thereby completing the head slider 15 depicted in FIG. 4.

In a modification example of the manufacturing method with the use of FIGS. 8 and 9A to 9F, only a portion where a chemical absorption layer is to be formed may be irradiated with an ultraviolet ray, without forming a resist on the portion near the magnetic head of the medium facing surface of the lubricating layer.

Next, the second head-slider manufacturing method according to the present embodiment is explained by using FIGS. 10 and 11A to 11D. FIG. 10 is a flowchart of the second head-slider manufacturing process according to the present embodiment. As depicted in FIG. 10, a resist is first formed near the magnetic head (Step S210). Specifically, with reference to FIG. 11A for explanation, a resist 103 is formed near a magnetic head 102 on a medium facing surface 101 of a head slider 100.

Next, a lubricating agent is vapor deposited on the medium facing surface of the head slider (Step S211). Specifically, with reference to FIG. 11B for explanation, a predetermined lubricating agent is heated and vapor evaporated, and its steam is attached to the medium facing surface 101 of the head slider 100 to form a lubricating layer 104. Here, since the resist 103 is formed on a portion of the medium facing surface 101 near the magnetic head 102, steam is not attached to that portion, and therefore no lubricating layer is formed.

Next, the resist is removed (Step S212). Specifically, with reference to FIG. 11C for explanation, the resist formed on the medium facing surface 101 of the head slider 100 is removed. With this, the lubricating layer 104 is formed with the portion near the magnetic head 102 being exposed.

Next, the lubricating layer is irradiated with an ultraviolet ray (Step S213). Specifically, with reference to FIG. 11D for explanation, the medium facing surface 101 of the head slider 100 is irradiated with an ultraviolet ray. With this, a chemical reaction occurs between the medium facing surface 101 and the lubricating layer 104. In place of an ultraviolet ray, for example, an X ray, an electron beam, a converged ion beam, laser light of infrared radiation, or others may be radiated as a high energy beam.

Next, the head slider is cleaned with a diluent solvent (Step S214), and is air dried (Step S215), thereby ending the process. With this, a portion of the lubricating layer formed on the head slider left as a physical absorption layer because no chemical reaction occurs is removed. Then, the head slider is left, and the diluent solvent evaporates, thereby completing the head slider 15 depicted in FIG. 4.

In a modification example of the manufacturing method with the use of FIGS. 10 and 11A to 11D, the lubricant agent may be vapor deposited over the entire medium facing surface and only a portion where a chemical absorption layer is to be formed may be irradiated with an ultraviolet ray, without forming a resist on the portion near the magnetic head of the medium facing surface of the lubricating layer.

While attachment of substances is prevented by a water-repellent material applied onto the medium facing surface, an area around the magnetic head is exposed. With this, a magnetic spacing similar to that when no water-repellent material is applied can be kept.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A head slider comprising:
a slider that is disposed at a tip of a supporting member, floats with an air flow occurring due to rotation of a storage medium, and has a medium facing surface onto which a water-repellent material is applied, with an area near the magnetic head being exposed; and
a magnetic head that is disposed at an air outflow end side of the slider and has a recording element and a reproducing element.

2. The head slider according to claim 1, wherein
a distance from a position on an air inflow end side near the magnetic head to an air outflow end side of the slider is represented by a value obtained by dividing a film thickness of the water-repellent material by a tangent of a pitch angle when the slider floats.

3. The head slider according to claim 1, wherein
the water-repellant material is water-repellant resin.

4. The head slider according to claim 1, wherein
the water-repellant material is a chemical absorption layer formed by a chemical reaction between the water-repellant resin and the medium facing surface of the slider.

5. A magnetic storage device comprising:
a storage medium;
a slider that is disposed at a tip of a supporting member, floats with an air flow occurring due to rotation of a storage medium, and has a medium facing surface onto which a water-repellent material is applied, with an area near the magnetic head being exposed;
a magnetic head that is disposed at an air outflow end side of the slider and has a recording element and a reproducing element; and
a signal processing board that processes a reproducing signal and a recording signal for reproducing and recording information by the storage medium and the magnetic head.

6. A head-slider manufacturing method of manufacturing a head slider with a magnetic head having a recording element and a reproducing element to cause the magnetic head to float over a storage medium, the method comprising:
forming a lubricating layer on a medium facing surface of the head slider;
irradiating the lubricating layer formed in the forming with a high energy beam except a portion near the magnetic head;
cleaning the lubricating layer irradiated with the high energy beam in the irradiating by using a solvent that can solve a lubricating agent that forms the lubricating layer.

7. The head-slider manufacturing method according to claim 6, further comprising:
forming a resist on a portion near the magnetic head of a medium facing surface of the lubricating layer prior to the irradiating, and
removing the resist after the irradiating.

8. The head-slider manufacturing method according to claim 6, wherein
in the irradiating, only a portion of the lubricating layer formed in the forming except the portion near the magnetic head is irradiated with the high energy beam.

9. A head-slider manufacturing method of manufacturing a head slider with a magnetic head having a recording element and a reproducing element to cause the magnetic head to float over a storage medium, the method comprising:
forming a resist near the magnetic head on a medium facing surface of the head slider;
forming a lubricating layer on the medium facing surface having the resist formed thereon in the forming;
irradiating the lubricating layer formed in the forming with a high energy beam; and
cleaning the lubricating layer irradiated with the high energy beam in the irradiating by using a lubricant-soluble solvent.
